(19) United States
(12) Patent Application Publication
(10) Pub. No.: US 2018/0190015 A1
(43) Pub. Date: Jul. 5, 2018

(54) 3D MODELING SYSTEM

(71) Applicant: HON HAI PRECISION INDUSTRY CO., LTD., New Taipei (TW)

(72) Inventors: HUAN-WEN CHEN, New Taipei (TW); KUO-KUANG LIAO, New Taipei (TW)

(21) Appl. No.: 15/786,619

(22) Filed: Oct. 18, 2017

(30) Foreign Application Priority Data
Dec. 29, 2016 (TW) 105143864

(51) Int. Cl. G06T 17/05; G01S 17/89; G01S 7/481; G06T 7/521

(52) U.S. Cl. CPC G06T 17/05; G01S 17/89; G06T 2207/10028; G06T 7/521; G01S 7/4813

(57) ABSTRACT

A 3D modeling system is related. The 3D modeling system includes a light detection and ranging (LiDAR) device and a computer connected to the LiDAR device. The LiDAR device transmits detecting light and receive reflective light to form a reflective points data. The computer controls the work of the LiDAR device, processes the reflective points data, and builds a 3D model according to the reflective points data. The 3D modeling system does not need assistant sensor and has simple structure and low cost.

### CROSS-REFERENCE TO RELATED APPLICATIONS

This application claims all benefits accruing under 35 U.S.C. § 119 from Taiwan Patent Application No. 105143864, filed on Dec. 29, 2016, in the Taiwan Intellectual Property Office, the contents of which are hereby incorporated by reference.

### BACKGROUND

### 1. Technical Field

The present disclosure relates to 3D modeling system and method based on a light detection and ranging (LiDAR).

### 2. Description of Related Art

LiDAR is a technology that utilizes lasers to determine the distance to an object or surface. It is used in a variety of industries, including atmospheric physics, geology, forestry, oceanography, and law enforcement. LiDAR is similar to radar, but it incorporates laser pulses rather than radio waves. Both systems determine distance by measuring the time delay between transmission and reflection of a pulse.

LiDAR is widely used in 3D modeling field. However, the conventional 3D modeling system usually includes many sensors such as global position system (GPS) and inertial measurement unit (IMU). Thus, the conventional 3D modeling system is complicated and has high cost.

What is needed, therefore, is to provide a 3D modeling system that can overcome the problems as discussed above.

### BRIEF DESCRIPTION OF THE DRAWINGS

Many aspects of the exemplary embodiments can be better understood with reference to the following drawings. The components in the drawings are not necessarily drawn to scale, the emphasis instead being placed upon clearly illustrating the principles of the exemplary embodiments. Moreover, in the drawings, like reference numerals designate corresponding parts throughout the several views.

FIG. 1 is a functional diagram of one exemplary embodiment of a 3D modeling system.

FIG. 2 shows a schematic view of one exemplary embodiment of a LiDAR device.

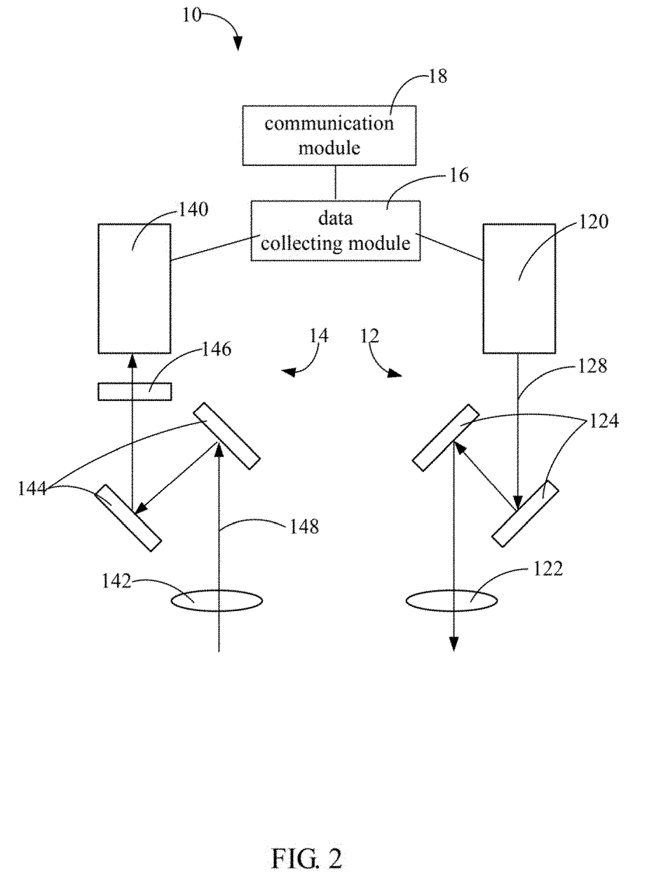

FIG. 3 is a functional diagram of one exemplary embodiment of a computer.

FIG. 4 is a work flow chart of one exemplary embodiment of the computer of the of FIG. 3.

FIG. 5 is a work flow chart of one exemplary embodiment of how to obtain a relative displacement.

FIG. 6 shows further work flow chart of one exemplary embodiment of the computer of the of FIG. 3.

FIG. 7 is 3D point cloud image of a building obtained by the 3D modeling system of FIG. 1.

FIG. 8 is 3D point cloud image of an office hallway obtained by the 3D modeling system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. The drawings are not necessarily to scale, and the proportions of certain parts may be exaggerated better illustrate details and features. The description is not to considered as limiting the scope of the exemplary embodiments described herein.

Several definitions that apply throughout this disclosure will now be presented. The terms “connected” and “coupled” are defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” exemplary embodiment in this disclosure are not necessarily to the same exemplary embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

References will now be made to the drawings to describe, in detail, various exemplary embodiments of the present light detection and ranging system.

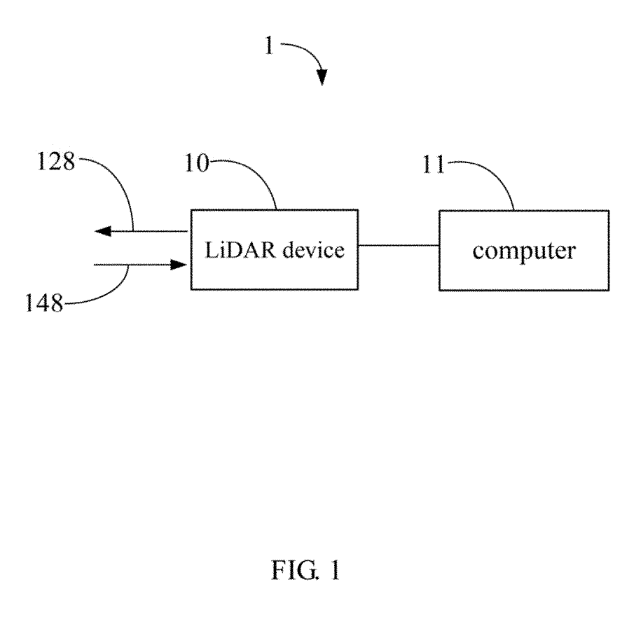

Referring to FIG. 1, a 3D modeling system 1 of one exemplary embodiment includes a LiDAR device 10 and a computer 11 connected to the LiDAR device 10. The LiDAR device 10 transmits and receives laser lights 128, 148 to form a reflective points data. The computer 11 controls the work of the LiDAR device 10, processes the reflective points data, and builds a 3D model according to the reflective points data.

The structure of the LiDAR device 10 is not limited and can be selected according too need. Referring to FIG. 1, in one exemplary embodiment, the LiDAR device 10 includes a light transmitting module 12, a light receiving module 14, a data collecting module 16 respectively connected to the light transmitting module 12 and the light receiving module 14, and a communication module 18 connected to the data collecting module 16.

The light transmitting module 12 includes a light transmitter 120, a first focusing lens 122, and two first reflective mirrors 124. The light receiving module 14 includes a light receiver 140, a second focusing lens 142, two second reflective mirrors 144, and a filter 146. The first laser light 128 emitted from the light transmitter 120 reaches and passes through the first focusing lens 122 after being reflected by the two first reflective mirrors 124. The first laser light 128 would be reflected by the object to form a second laser light 148. The second laser light 148 passes through the second focusing lens 142 and reaches the filter 146 after being reflected by the two second reflective mirrors 144. The second laser light 148, that pass through the filter 146, are absorbed by the light receiver 140 to form a reflective points data. At least one of the light transmitting module 12 and the light receiving module 14 can includes a planar waveguide (not shown) to submit the two first reflective mirrors 124 or the two second reflective mirrors 144. The planar waveguide includes a substrate and a refracting element. The data collecting module 16 controls the LiDAR device 10 to obtain the reflective points data. The communication module 18 communicates with the computer 11, such as send the reflective points data to the computer 11. The collecting module 16 can be connected to the light transmitting module 12 and the light receiving module 14 by wires or wireless. The communication module 18 can be connected to the data collecting module 16 and the computer 11 by wires or wireless.

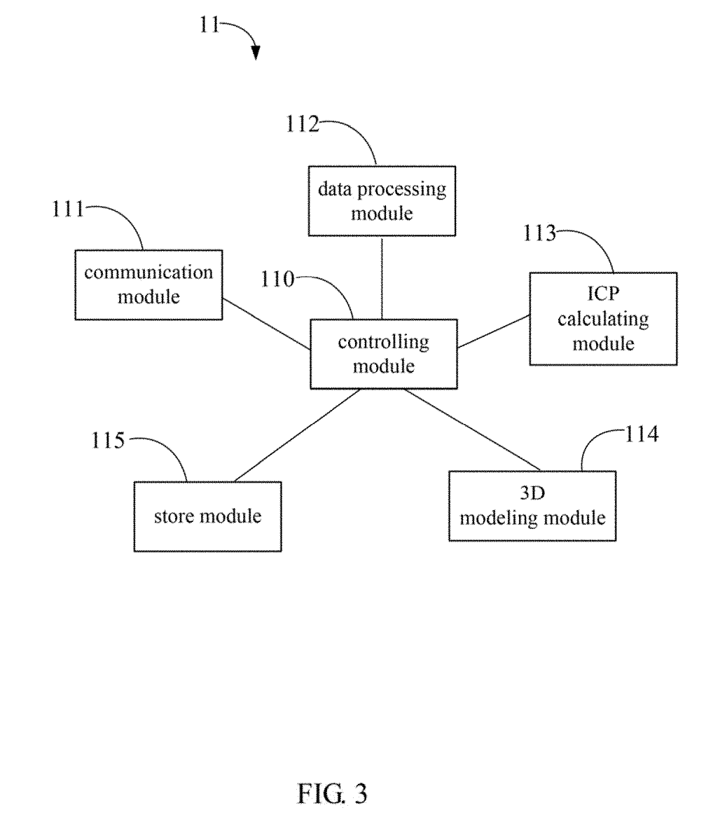

The computer 11 can be an independent computer. The computer 11 and the LiDAR device 10 can also be integrated and accommodated in the same housing. The computer 11 is a micro-processor. The computer 11 includes a hardware and a software loaded on the hardware. Referring to FIG. 3, in one exemplary embodiment, the software of the computer 11 includes a controlling module 110, a communication module 111, a data processing module 112, an iterative closest point (ICP) calculating module 113, a 3D modeling module 114, and a store module 115. The communication module 111, the data processing module 112, the ICP calculating module 113, the 3D modeling module 114, and the store module 115 are respectively connected to the controlling module 110. The communication module 111 communicates with the LiDAR device 10, such as receive the reflective points data. The data processing module 112 converts the format of the reflective points data to another format that can be read by the computer 11. The ICP calculating module 113 calculates the reflective points data by ICP method and obtains a 3D point cloud. The 3D modeling module 114 builds a 3D model according to the 3D point cloud. The store module 115 stores data.

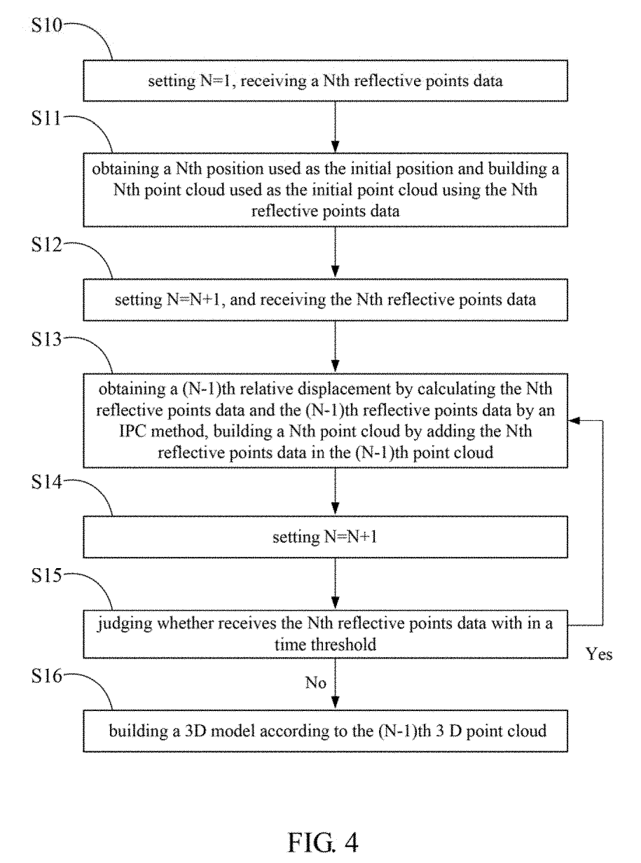

In operation of the 3D modeling system 1, the LiDAR device 10 continuously collects the reflective points data from ambient environment, and sends the reflective points data to the computer 11. Referring to FIG. 4, in one exemplary embodiment, the work method of the computer 11 includes following steps:
step S10, setting N=1, receiving a Nth reflective points data, go to step S11;
step S11, obtaining a Nth position used as the initial position and building a Nth point cloud used as the initial point cloud using the Nth reflective points data, and go to step S12;
step S12, setting N=N+1, and receiving the Nth reflective points data, go to step S13;
step S13, obtaining a (N−1)th relative displacement by calculating the Nth reflective points data and the (N−1)th reflective points data by an IPC method, building a Nth point cloud by adding the Nth reflective points data in the (N−1)th point cloud, and go to step S14;
step S14, setting N=N+1, go to step S15;
step S15, judging whether receives the Nth reflective points data with in a time threshold, if yes, returns to step S13, if no, go to step S16; and
step S16, building a 3D model according to the (N−1)th 3D point cloud.

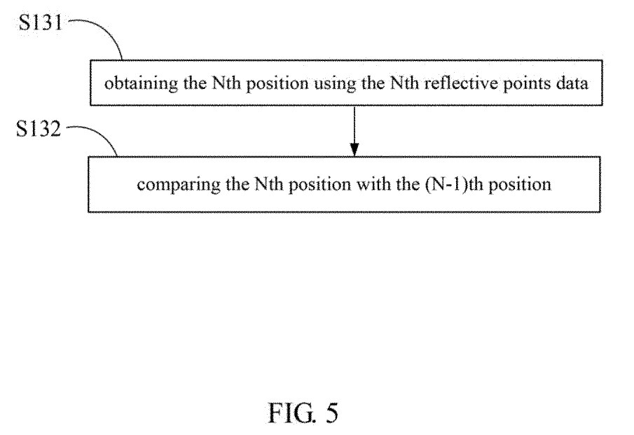

Referring to FIG. 5, in step S13, the obtaining the (N−1)th relative displacement comprises:
step S131, obtaining the Nth position using the Nth reflective points data; and
step S132, comparing the Nth position with the (N−1)th position.

In step S15, the time threshold can be selected according to need or experience. In one exemplary embodiment, the time threshold is from 1 minute to 5 minutes. According to step S15, when new reflective points data is received, the new reflective points data would be added in the point cloud.

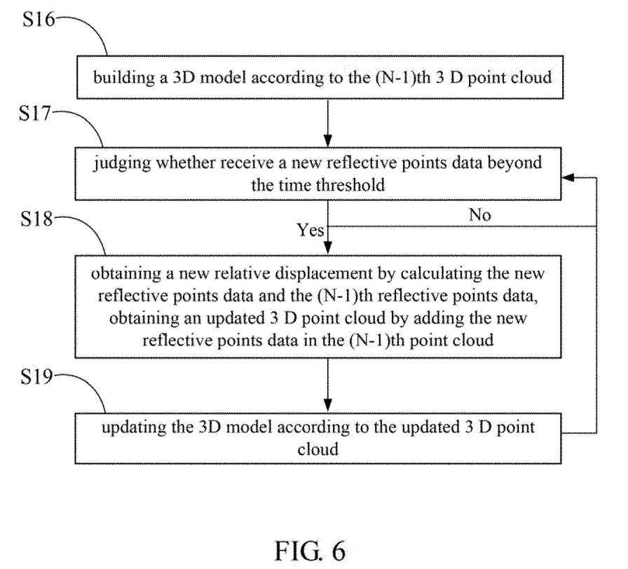

Referring to FIG. 6, in one exemplary embodiment, the work method of the computer 11 further includes following steps:
step S17, judging whether receive a new reflective points data beyond the time threshold, if yes, go to step S18, if no, repeating step S17;
step S18, obtaining a new relative displacement by calculating the new reflective points data and the (N−1)th reflective points data, obtaining an updated 3D point cloud by adding the new reflective points data in the (N−1)th point cloud, and go to step S19; and
step S19, updating the 3D model according to the updated 3D point cloud, and returns to step S17.

According to step S17, the 3D model can be updated according to the new reflective points data is received in time.

In anther one exemplary embodiment, the work method of the computer 11 further includes following steps:
step S17, judging whether receive the Nth reflective points data beyond the time threshold, if yes, returns to step S13, if no, repeating step S17.

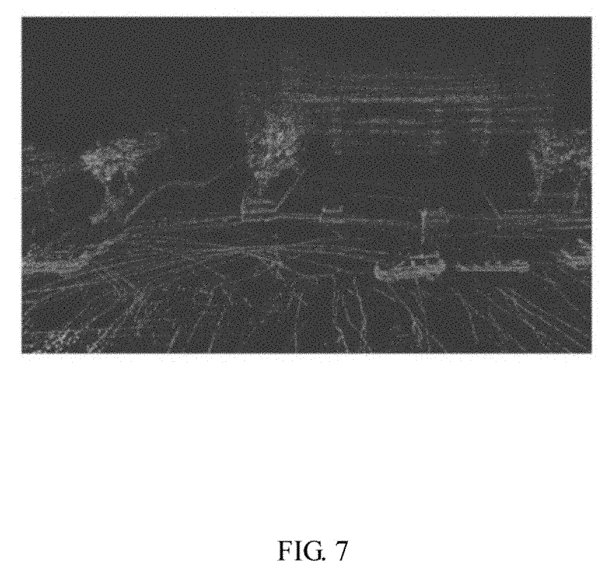

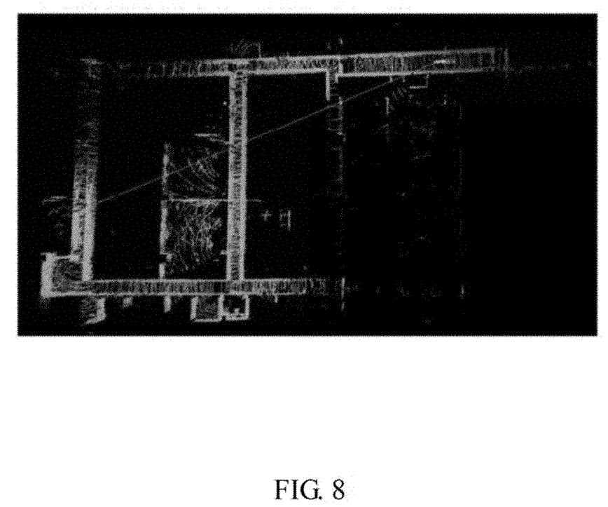

In one exemplary embodiment, the 3D modeling system 1 is installed on a car, and the car is driven to surround a building to collect the reflective points data. FIG. 7 shows a 3D point cloud image of the building obtained by the 3D modeling system 1. In one exemplary embodiment, one people takes the 3D modeling system 1 and moves in an office hallway to collect the reflective points data. FIG. 8 shows a 3D point cloud image of the office hallway obtained by the 3D modeling system 1.

The 3D modeling system 1 does not need assistant sensor and has simple structure and low cost because the LiDAR device is used to collect the reflective points data. The 3D modeling system 1 can be taken in hand or installed on a robot, a flying device, or a car.

It is to be understood that the above-described exemplary embodiments are intended to illustrate rather than limit the disclosure. Any elements described in accordance with any exemplary embodiments is understood that they can be used in addition or substituted in other exemplary embodiments. Exemplary embodiments can also be used together. Variations may be made to the exemplary embodiments without departing from the spirit of the disclosure. The above-described exemplary embodiments illustrate the scope of the disclosure but do not restrict the scope of the disclosure.

Depending on the exemplary embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A 3D modeling system, comprising:
a light detection and ranging (LiDAR) device, wherein the LiDAR device transmits and receives laser lights to form a reflective points data; and
a computer connected to the LiDAR device, wherein the computer controls the LiDAR device, processes the reflective points data, and builds a 3D model according to the reflective points data.

2. The 3D modeling system of claim 1, wherein the computer and the LiDAR device are integrated and accommodated in the same housing.

3. The 3D modeling system of claim 1, wherein the LiDAR device comprises a light transmitting module, a light receiving module, a data collecting module respectively connected to the light transmitting module and the light receiving module, and a communication module connected to the data collecting module.

4. The 3D modeling system of claim 3, wherein the light transmitting module comprises a light transmitter, a first focusing lens, and two first reflective mirrors.

5. The 3D modeling system of claim 3, wherein the light receiving module comprises a light receiver, a second focusing lens, two second reflective mirrors, and a filter.

6. The 3D modeling system of claim 1, wherein the computer is a micro-processor.

7. The 3D modeling system of claim 1, wherein the computer comprises a controlling module, a communication module, a data processing module, an iterative closest point (ICP) calculating module, a 3D modeling module, and a store module.

8. The 3D modeling system of claim 7, wherein the data processing module converts a first format of the reflective points data to a second format that can be read by the computer, the ICP calculating module calculates the reflective points data and obtains a 3D point cloud; and the 3D modeling module builds a 3D model according to the 3D point cloud.

9. The 3D modeling system of claim 8, wherein a work method of the computer comprises following steps:
step S10, setting N=1, receiving a Nth reflective points data, go to step S11;
step S11, obtaining a Nth position and building a Nth point cloud by the Nth reflective points data, and go to step S12;
step S12, setting N=N+1, and receiving the Nth reflective points data, go to step S13;
step S13, obtaining a (N−1)th relative displacement by calculating the Nth reflective points data and the (N−1)th reflective points data by an IPC method, building a Nth point cloud by adding the Nth reflective points data in the (N−1)th point cloud, and go to step S14;
step S14, setting N=N+1, go to step S15;
step S15, judging whether receives the Nth reflective points data with in a time threshold, if yes, returns to step S13, if no, go to step S16; and
step S16, building a 3D model according to the (N−1)th 3 D point cloud.

10. The 3D modeling system of claim 9, wherein the obtaining the (N−1)th relative displacement comprises:
obtaining the Nth position using the Nth reflective points data; and
comparing the Nth position with the (N−1)th position.

11. The 3D modeling system of claim 8, wherein a work method of the computer further comprises following steps:
step S10, setting N=1, receiving a Nth reflective points data, go to step S11;
step S11, obtaining a Nth position and building a Nth point cloud by the Nth reflective points data, and go to step S12;
step S12, setting N=N+1, and receiving the Nth reflective points data, go to step S13;
step S13, obtaining a (N−1)th relative displacement by calculating the Nth reflective points data and the (N−1)th reflective points data by an IPC method, building a Nth point cloud by adding the Nth reflective points data in the (N−1)th point cloud, and go to step S14;
step S14, setting N=N+1, go to step S15;
step S15, judging whether receives the Nth reflective points data with in a time threshold, if yes, returns to step S13, if no, go to step S16;
step S16, building a 3D model according to the (N−1)th 3 D point cloud, go to steps S17;
step S17, judging whether receive a new reflective points data beyond the time threshold, if yes, go to step S18, if no, repeating step S17;
step S18, obtaining a new relative displacement by calculating the new reflective points data and the (N−1)th reflective points data, obtaining an updated 3D point cloud by adding the new reflective points data in the (N−1)th point cloud, and go to step S19; and
step S19, updating the 3D model according to the updated 3D point cloud, and returns to step S17.

12. The 3D modeling system of claim 11, wherein the obtaining the (N−1)th relative displacement comprises:
obtaining the Nth position using the Nth reflective points data; and
comparing the Nth position with the (N−1)th position.

13. The 3D modeling system of claim 8, wherein a work method of the computer further comprises following step:
step S10, setting N=1, receiving a Nth reflective points data, go to step S11;
step S11, obtaining a Nth position and building a Nth point cloud by the Nth reflective points data, and go to step S12;
step S12, setting N=N+1, and receiving the Nth reflective points data, go to step S13;
step S13, obtaining a (N−1)th relative displacement by calculating the Nth reflective points data and the (N−1)th reflective points data by an IPC method, building a Nth point cloud by adding the Nth reflective points data in the (N−1)th point cloud, and go to step S14;
step S14, setting N=N+1, go to step S15;
step S15, judging whether receives the Nth reflective points data with in a time threshold, if yes, returns to step S13, if no, go to step S16;
step S16, building a 3D model according to the (N−1)th 3 D point cloud, go to steps S17; and
step S17, judging whether receive the Nth reflective points data beyond the time threshold, if yes, returns to step S13, if no, repeating step S17.

14. The 3D modeling system of claim 13, wherein the obtaining the (N−1)th relative displacement comprises:
obtaining the Nth position using the Nth reflective points data; and
comparing the Nth position with the (N−1)th position.

15. The 3D modeling system of claim 1, wherein the 3D modeling system consists of the LiDAR device and the computer.
